(19) United States
(12) Patent Application Publication
(10) Pub. No.: US 2026/0319417 A1
(43) Pub. Date: Oct. 15, 2026

(54) APPARATUS THAT MAKES BOOKLET USING TONER

(71) Applicant: CANON KABUSHIKI KAISHA, Tokyo (JP)

(72) Inventors: KODAI HAYASHI, Shizuoka (JP); KEITARO NAKATA, Shizuoka (JP); TAKU WATANABE, Shizuoka (JP)

(21) Appl. No.: 19/463,264

(22) Filed: Jan. 29, 2026

(30) Foreign Application Priority Data
Feb. 3, 2025 (JP) 2025-016283

(51) Int. Cl. G03G 15/00; G03G 15/043; G03G 21/18

(52) U.S. Cl. CPC G03G 15/553; G03G 15/043; G03G 15/5066; G03G 15/6544; G03G 21/1878; G03G 2215/00772; G03G 2215/00936; G03G 2221/1823

(57) ABSTRACT

A control unit adjusts a booklet making condition in accordance with at least one of a wear state of an image forming unit and an environmental condition in an environment in which the image forming unit is installed. The booklet making condition includes at least one of an image forming condition for an adhesive layer, used in the image forming unit, and a thermal compression adhering condition for the adhesive layer, used in a thermal compression adhering unit.

### BACKGROUND

### FIELD OF THE TECHNOLOGY

The present disclosure relates to an apparatus that makes a booklet using toner.

### DESCRIPTION OF THE RELATED ART

A booklet is made by using metal staples to bind a plurality of sheets on which images have been printed by an image forming apparatus. However, using metal staples makes it difficult to recycle such booklets. Accordingly, Japanese Patent Laid-Open No. 2004-209859 proposes using toner as an adhesive instead of metal staples to make a booklet.

A process cartridge of an image forming apparatus is constituted by consumables such as toner, a photosensitive drum, and a developing roller. The state of a consumable changes according to the cumulative operation time of the process cartridge. Furthermore, the state of the consumable (e.g., the physical properties of toner) changes in accordance with the conditions of the environment in which the image forming apparatus is installed (e.g., temperature). Image forming apparatuses have a function for automatically adjusting image forming conditions in consideration of the cumulative operation time and environmental conditions. Adhesive layers are also affected by the cumulative operation time and environmental conditions, but booklet making apparatuses have not taken such effects into consideration, and thus booklets may have insufficient adhesion strength.

### SUMMARY

The disclosure provides a booklet making apparatus comprising a stacker unit on which a plurality of sheets are stackable, the plurality of sheets including a sheet on which an image and an adhesive layer are formed by an image forming unit using toner, a thermal compression adhering unit configured to make a booklet by heating and pressing the adhesive layer formed on at least one sheet among the plurality of sheets; and a control unit configured to control the thermal compression adhering unit. The control unit adjusts a booklet making condition in accordance with at least one of a wear state of the image forming unit and an environmental condition in an environment in which the image forming unit is installed, the booklet making condition including at least one of (i) an image forming condition for the adhesive layer, which is used in the image forming unit, and (ii) a thermal compression adhering condition for the adhesive layer, which is used in the thermal compression adhering unit.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an image forming system.

FIGS. 2A to 2C are diagrams illustrating formation positions of adhesive images.

FIGS. 3A to 3D are diagrams illustrating a method for making a booklet.

FIGS. 4A to 4B are diagrams illustrating thermal compression adhering processing.

FIG. 5 is a diagram illustrating a thermal compression adhering position.

FIGS. 6A and 6B are diagrams illustrating adhesion strength.

FIG. 7 is a diagram illustrating a process cartridge.

FIG. 8 is a diagram illustrating a controller.

FIGS. 9A and 9B are diagrams illustrating correction tables.

FIG. 10 is a flowchart illustrating a control method.

FIG. 11 is a diagram illustrating an effect.

FIGS. 12A and 12B are diagrams illustrating correction tables.

FIG. 13 is a diagram illustrating an exposure apparatus.

FIG. 14 is a diagram illustrating exposure control.

FIG. 15 is a flowchart illustrating a control method.

FIG. 16 is a diagram illustrating an image forming system.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### 1. First Embodiment

### 1-1. Image Forming System

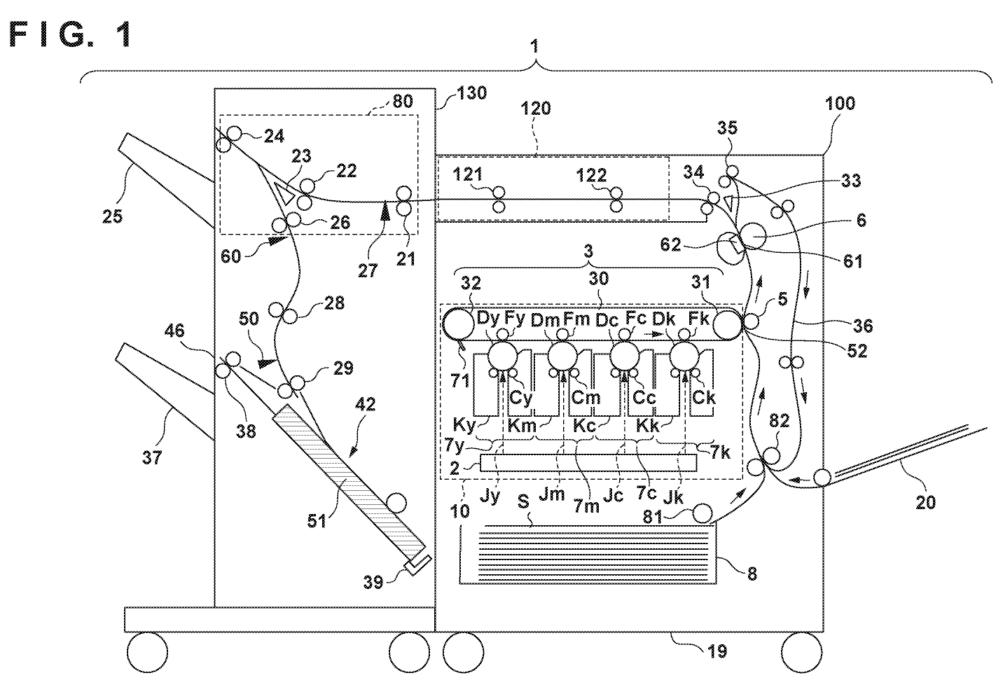

As illustrated in FIG. 1, an image forming system 1 includes an image forming apparatus 100 and a post-processing apparatus 130. The post-processing apparatus 130 is a sheet processing apparatus connected to the image forming apparatus 100. The image forming apparatus 100 forms an image on a sheet S, which is a recording material. An intermediate conveyance unit 120 conveys the sheet S on which the image has been formed to the post-processing apparatus 130. The post-processing apparatus 130 performs post-processing on the sheet S and outputs the processed sheet as necessary. Note that the image forming system 1 may be understood as being a booklet making apparatus, or the post-processing apparatus 130 may be understood as being a booklet making apparatus. The image forming system 1 may be called an “image forming apparatus”.

The image forming apparatus 100 includes a fixing apparatus 6, a sheet cassette 8, an image forming portion 10, and a housing 19 that houses these components. The image forming portion 10 forms a toner image on the sheet S fed from the sheet cassette 8. The fixing apparatus 6 executes fixing processing for fixing the toner image onto the sheet S.

The sheet cassette 8 is provided in a lower part of the image forming apparatus 100. The sheet cassette 8 is inserted into the housing 19 so as to be removable therefrom, and can hold a large number of sheets S. In the present embodiment, the maximum size for the sheet S on which an image can be formed is assumed to be A4 size (297 mm in height × 210 mm in width). The long side of the A4-size sheet S is parallel to a conveyance direction of the sheet S. A feed roller 81 feeds the sheet S from the sheet cassette 8 and passes the sheet S to a conveyance roller pair 82. A multi-tray 20 can also feed the sheets S one at a time.

The image forming portion 10 is a tandem-type electrophotographic unit provided with four process cartridges 7y, 7m, 7c, and 7k, an exposure apparatus 2, and a transfer unit 3. “y”, “m”, “c”, and “k” refer to “yellow”, “magenta”, “cyan”, and “black”, respectively. A transparent toner (a powder adhesive) may be used instead of black. The toner used as the powder adhesive may also be called “adhesive toner Tn”. The letters “y”, “m”, “c”, and “k”, indicating the colors of the toner, may be omitted from the reference signs. The adhesive toner Tn may be transparent or black. If the adhesive toner is transparent, black (process black) is realized by mixing yellow, magenta, and cyan as appropriate. The toner type (material) used as the yellow, magenta, and cyan toners and the adhesive toner Tn is, for example, a thermoplastic resin. Thermoplastic resins include, for example, polyester resin, vinyl resin, acrylic resin, styrene acrylic resin, and the like. The process cartridges 7y, 7m, 7c, and 7k enable a plurality of components that handle the image forming process to be replaced collectively. In other words, a plurality of components are integrated to form the process cartridges 7y, 7m, 7c, and 7k. Note that the arrangement of the process cartridges 7y, 7m, 7c, and 7k in a rotation direction of a transfer belt 30 is merely one example. The process cartridges 7y, 7m, 7c, and 7k are examples of consumables that can be replaced.

The process cartridges 7y, 7m, 7c, and 7k include corresponding developing apparatuses Ky, Km, Kc, and Kk, photosensitive drums Dy, Dm, Dc, and Dk, and charging rollers Cy, Cm, Cc, and Ck. The structures of the process cartridges 7y, 7m, 7c, and 7k are substantially the same as each other, except for the types of toner used therein.

Each of the developing apparatuses Ky, Km, Kc, and Kk includes a container containing a powder (e.g., toner) and an application roller (application sleeve) for applying the powder to the photosensitive drums Dy, Dm, Dc, and Dk. More specifically, the developing apparatuses Ky, Km, and Kc contain yellow, magenta, and cyan toners, respectively, for forming a visible image on the sheet S. The developing apparatus Kk holds black toner (the adhesive toner Tn). The adhesive toner Tn forms a user image (original image), and may be used in the post-processing apparatus 130 for thermal compression adhering of a plurality of the sheets S. Note that an adhesive image (an adhesive layer) of the adhesive toner Tn is formed on the photosensitive drum Dk as a result of developing using the adhesive toner Tn.

The image forming portion 10 may include a fifth process cartridge using an adhesive-only toner. Note that the type of printing toner (e.g., black or transparent) and the number of process cartridges 7 can be changed in accordance with the purpose of the image forming apparatus 100.

The charging rollers Cy, Cm, Cc, and Ck are chargers, and uniformly charge the surfaces of corresponding ones of the photosensitive drums Dy, Dm, Dc, and Dk. The exposure apparatus 2 is disposed below the process cartridges 7y, 7m, 7c, and 7k, and above the sheet cassette 8. The exposure apparatus 2 forms an electrostatic latent image by irradiating the photosensitive drums Dy, Dm, Dc, and Dk with corresponding laser beams Jy, Jm, Jc, and Jk. The exposure apparatus 2 may be called an “optical scanning apparatus”.

The developing apparatuses Ky, Km, Kc, and Kk form toner images by causing the toner to adhere to the electrostatic latent images on the photosensitive drums Dy, Dm, Dc, and Dk. The developing apparatuses Ky, Km, Kc, and Kk may be called “developing apparatuses”.

The transfer unit 3 includes the transfer belt 30, which serves as an intermediate transfer member (a secondary image carrier). The transfer belt 30 is an endless belt stretched upon an inner roller 31 and a tension roller 32. An outer circumferential surface (image forming surface) of the transfer belt 30 faces the photosensitive drums Dy, Dm, Dc, and Dk. Primary transfer rollers Fy, Fm, Fc, and Fk are disposed on an inner circumferential side of the transfer belt 30 so as to face the photosensitive drums Dy, Dm, Dc, and Dk.

The primary transfer rollers Fy, Fm, Fc, and Fk transfer toner images from the corresponding photosensitive drums Dy, Dm, Dc, and Dk to the transfer belt 30. The primary transfer rollers Fy, Fm, Fc, and Fk may be called “primary transfer devices”. When the transfer belt 30 rotates counterclockwise, the toner images are conveyed to a secondary transfer portion.

A secondary transfer roller 5 is disposed opposite the inner roller 31, and a transfer nip 52 is formed between the secondary transfer roller 5 and the transfer belt 30. The transfer nip 52 transfers the toner image from the transfer belt 30 to the sheet S. The transfer nip 52 may be called a “secondary transfer portion”. A cleaning blade 71 is a cleaning member for removing toner remaining on the transfer belt 30. Toner removed by the cleaning blade 71 is collected into a collection container (not shown).

The fixing apparatus 6 is disposed above the secondary transfer roller 5 (downstream in the conveyance direction of the sheet S). The fixing apparatus 6 applies heat and pressure to the sheet S as the sheet S traverses a fixing nip 61. The toner images are fixed onto the sheet S as a result. Note that the fixing apparatus 6 includes a fixing heater 62 for heating the toner images and the sheet S. The fixing heater 62 is a halogen heater or a ceramic heater, for example.

As illustrated in FIG. 1, a switching guide 33 is a flap-shaped guide member provided downstream from the fixing apparatus 6 in the conveyance direction of the sheet S. When a single-sided printing mode, in which an image is formed on one surface of the sheet S, is selected, the switching guide 33 guides the sheet S to discharge rollers 34. When a double-sided printing mode, in which an image is formed on both surfaces of the sheet S, is selected, the switching guide 33 guides the sheet S having an image formed on a first surface to a switchback roller pair 35. The switchback roller pair 35 conveys the sheet S in a predetermined direction. When a trailing end of the sheet S can enter a double-sided conveyance path 36, the switchback roller pair 35 starts to reverse. As a result, the sheet S is conveyed to the double-sided conveyance path 36. The double-sided conveyance path 36 conveys the sheet S to the secondary transfer portion again. An image is formed on a second surface of the sheet S as a result.

The discharge rollers 34 convey the sheet S to the intermediate conveyance unit 120. The intermediate conveyance unit 120 has conveyance roller pairs 121 and 122. The conveyance roller pairs 121 and 122 convey the sheet S to the post-processing apparatus 130.

### 1-2. Post-Processing Apparatus

The post-processing apparatus 130 is a floor-standing sheet processing apparatus. The post-processing apparatus 130 has a mechanism for buffering a plurality of sheets, a mechanism for aligning a plurality of sheets, and a mechanism for adhering (thermal compression adhering) a sheet bundle.

In the following, the end of the sheet S on the front side thereof in the conveyance direction will be called a “leading end”. Similarly, the end of the sheet S on the rear side thereof in the conveyance direction will be called a “trailing end”. Of the two ends of the sheet S, the end that enters the post-processing apparatus 130 first will be called a “first end”. Meanwhile, of the two ends of the sheet S, the end that enters the post-processing apparatus 130 later will be called a “second end”. Note that switch-back conveyance performed by the post-processing apparatus 130 may result in the leading end changing from the first end to the second end and the trailing end changing from the second end to the first end.

The sheet S conveyed from the intermediate conveyance unit 120 is passed to inlet rollers 21 of the post-processing apparatus 130. A sheet sensor 27, called an “inlet sensor”, is disposed downstream from the inlet rollers 21. When the sheet sensor 27 senses the trailing end of the sheet S, a conveyance roller pair 22 accelerates the sheet S. When the trailing end of the sheet S for which the discharge destination is set to an upper tray 25 reaches an area between the conveyance roller pair 22 and a conveyance roller pair 24, the conveyance roller pair 22 decelerates. As a result, the conveyance speed of the sheet S is set to a predetermined discharge speed. The conveyance roller pair 24 discharges the sheet S to the upper tray 25.

When the trailing end of the sheet S for which the discharge destination is set to a lower tray 37 passes a backflow prevention member 23, the conveyance roller pair 24 stops conveying the sheet S. The conveyance roller pair 24 then begins rotating in reverse. As a result, the sheet S is switched back and conveyed to a conveyance roller pair 26. When a sheet sensor 60 provided downstream from the conveyance roller pair 26 senses the leading end of the sheet S, the two rollers constituting the conveyance roller pair 24 separate from each other. This enables the conveyance roller pair 24 to accept a subsequent sheet S. Furthermore, the conveyance roller pair 26 stops in a state where the preceding sheet S is pinched between the conveyance roller pair 26. When the subsequent sheet S arrives, the conveyance roller pair 26 starts rotating in reverse. The subsequent sheet S is overlaid onto the preceding sheet S as a result. When the conveyance roller pair 26 repeats the switchback of the sheets S, a plurality of the sheets S are stacked and a sheet bundle is formed. Such an operation for forming a sheet bundle may be called a “buffering operation”. A unit that implements the buffering operation is called a “buffer portion 80”. Note that it is not necessary to form the sheet bundle using the buffer portion 80. For example, the buffer portion 80 may switch back the sheet S that has arrived from the image forming apparatus 100, and then convey the sheet S to an intermediate stacker portion 42. In this case, a sheet bundle is formed in the intermediate stacker portion 42.

When the sheet bundle is completed in the buffer portion 80, the conveyance roller pair 26 conveys the sheet bundle toward the intermediate stacker portion 42. The sheet bundle traverses a conveyance roller pair 28 and a sheet sensor 50. Furthermore, the sheet bundle is conveyed to the intermediate stacker portion 42 by a kick-out roller pair 29. A longitudinal alignment plate 39, which is movable, is disposed in a standby position, at a part of the intermediate stacker portion 42 that is furthest downstream. When the sheet bundle presses against the longitudinal alignment plate 39, the sheet bundle is aligned.

A plurality of sheet bundles are stacked in order on the intermediate stacker portion 42. Note that the sheet bundle that is conveyed to the intermediate stacker portion 42 first will be called a “first sheet bundle”. The sheet bundle that arrives at the intermediate stacker portion 42 i-th in order will be called an “i-th sheet bundle”. The sheet bundle that arrives at the intermediate stacker portion 42 last will be called an “N-th sheet bundle”. As a result, a predetermined number of sheets S that are to form a booklet are stacked on the intermediate stacker portion 42. Once a predetermined number of sheets S have been aligned, a booklet is formed by a thermal compression adhering unit 51 performing a binding operation (thermal compression adhering processing). The thermal compression adhering processing may be repeated each time a sheet bundle arrives at the intermediate stacker portion 42. The longitudinal alignment plate 39 moves from the standby position to a discharge position, and as a result, the booklet is pushed toward discharge rollers 38. Once the leading end of the booklet is pinched by the discharge rollers 38, the longitudinal alignment plate 39 stops and then returns to the standby position. The booklet received from the longitudinal alignment plate 39 is discharged to the lower tray 37 from a discharge port 46 by the discharge rollers 38.

The foregoing described the post-processing apparatus 130 as forming a sheet bundle constituted by a plurality of sheets S by using the buffer portion 80, and conveying the sheet bundle to the intermediate stacker portion 42. However, a single sheet S may be conveyed to the intermediate stacker portion 42.

### 1-3. Printing Region of Adhesive Toner Tn

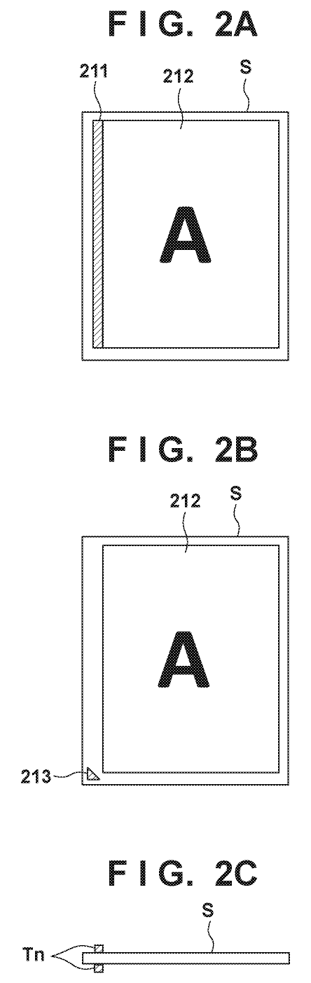

FIG. 2A illustrates a printing region 211 of the adhesive toner Tn. The printing region 211 is an adhesive region secured in the binding margin of the sheet S. In this example, the printing region 211 extends parallel to the long side of the sheet S. The printing region 211 is provided at the left end or the right end near the long side. The printing region 211 of a right-bound booklet is disposed at the right end of the sheet S. The printing region 211 of a left-bound booklet is disposed at the left end of the sheet S. The printing region 211 may be provided at the upper end or the lower end near the short side. By overlaying a plurality of sheets S and performing heat treatment and pressure treatment on the printing regions 211 of the plurality of sheets S, the post-processing apparatus 130 adheres the plurality of sheets S to each other to form a booklet. In this case, the booklet is bound on the long side. Here, the width (the length in the short side direction) of the adhesive toner image (the printing region 211) is 4.0 mm, for example. For example, the amount of toner per unit area of the adhesive toner Tn (i.e., the loading amount) may be 0.4 mg/cm². A printing region 212 is a region in which a user image is printed.

As illustrated in FIG. 2B, a small printing region 213 for the adhesive toner Tn may be formed near a corner of the sheet S. A booklet bound at the corner is made as a result. The image of the adhesive toner Tn is not formed on the sheet S that serves as the cover of the booklet. The printing region 213 of a right-bound booklet is disposed in the upper-right of the sheet S. The printing region 213 of a left-bound booklet is disposed in the upper-left of the sheet S.

As illustrated in FIG. 2C, the printing regions 211 and 213 of the adhesive toner Tn may be formed on both surfaces of the sheet S, or may be formed on only one surface of the sheet S. For example, whether the printing regions 211 and 213 of the adhesive toner Tn are formed on only one surface or on both surfaces can be selected in consideration of the adhesive performance of the post-processing apparatus 130, the adhesive performance of the adhesive toner Tn, the type of the sheet S, and the purpose of the booklet. Reliable adhesion is necessary for booklets that will be handled as archival editions. Reliable adhesion is also necessary when heavy paper or a special sheet S is used for the cover of the booklet. Accordingly, in these cases, the printing region 211 of the adhesive toner Tn is provided on both surfaces of the sheet S. However, when making a simple booklet for temporary use, the printing region 211 of the adhesive toner Tn may be formed on only one surface of the sheet S.

When the adhesive toner Tn is applied to both surfaces of the sheet S, the adhesive toner Tn formed on the front surface of one sheet S and the adhesive toner Tn formed on the back surface of another sheet S are placed in contact with and adhered to each other. Note that the adhesive toner Tn is applied to the back surface of the front cover of the booklet and the front surface of the back cover of the booklet, but is not applied to the front surface of the front cover of the booklet, nor to the back surface of the back cover of the booklet.

### 1-4. Booklet Making Operations

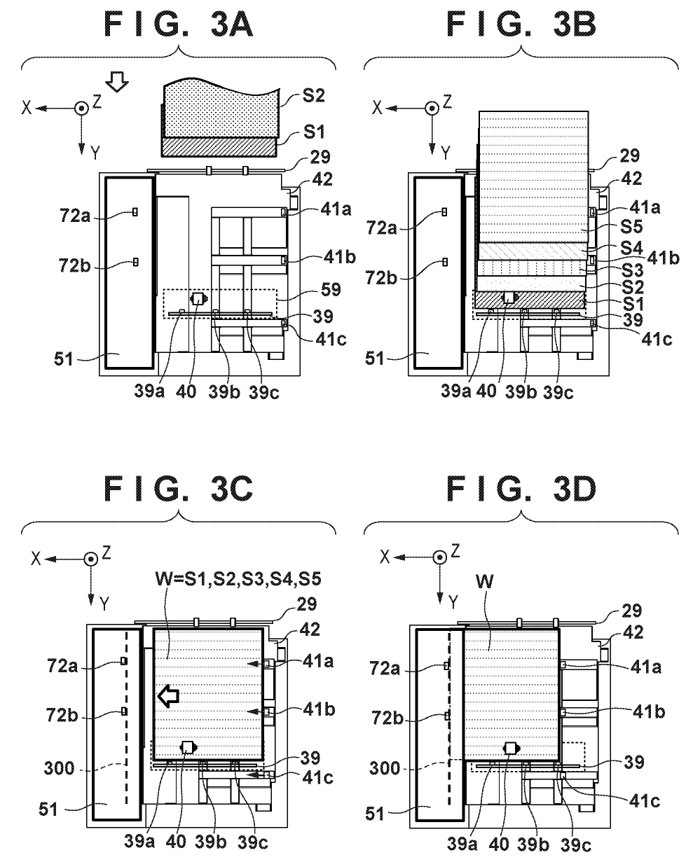

FIGS. 3A to 3D illustrate booklet making operations performed by the intermediate stacker portion 42. The initial state is a state in which the intermediate stacker portion 42 is empty. As an example, a sheet bundle W constituted by five sheets S1 to S5 is conveyed from the buffer portion 80 to the intermediate stacker portion 42. The intermediate stacker portion 42 functions as a support member or a holding member that supports the five sheets S1 to S5.

A Y direction is a direction parallel to a stacking surface (stacking plate) of the intermediate stacker portion 42 on which the sheets S are stacked, and parallel to the conveyance direction of the sheets S conveyed from the kick-out roller pair 29 to the intermediate stacker portion 42. The Y direction may be called a “longitudinal direction”. An X direction is a direction parallel to the stacking surface of the intermediate stacker portion 42 on which the sheets S are stacked, and orthogonal to the Y direction. The X direction may also be called a “lateral direction”. A Z direction is a direction orthogonal to the X direction and the Y direction (the normal direction of the stacking surface; the thickness direction of the stacked sheets S). The Z direction may also be called a “height direction”. The opposite directions for the X direction, the Y direction, and the Z direction may be called the “−X direction”, the “−Y direction”, and the “−Z direction”, respectively.

The longitudinal alignment plate 39 and an alignment roller 40 function as a first alignment unit that aligns a plurality of the sheets S in a first direction (the Y direction). The longitudinal alignment plate 39 is disposed at the part of the intermediate stacker portion 42 furthest downstream in the Y direction. The longitudinal alignment plate 39 is a reference member (first reference member) that serves as a reference for a sheet position in the Y direction. The alignment roller 40 is a conveyance member that conveys the sheets S in the Y direction in order to align the sheets S by pressing the sheets S against the longitudinal alignment plate 39. The longitudinal alignment plate 39 includes a plurality of contact portions 39a to 39c disposed at intervals in the X direction. The contact portions 39a to 39c may also be called “longitudinal reference plates”. The plurality of contact portions 39a to 39c make contact with the ends of the sheets S. The longitudinal alignment plate 39 and the alignment roller 40 are integrally configured as a movable unit 59 capable of moving in the Y direction. The movable unit 59 can move in the Y direction using a drive source such as a motor. In other words, the positions of the longitudinal alignment plate 39 and the alignment roller 40 in the Y direction can be adjusted. Lateral alignment plates 41a to 41c of a lateral alignment jogger 41 function as an alignment unit that aligns the sheets S in the X direction orthogonal to the Y direction.

The lateral alignment plates 41a to 41c move in the X direction using a drive source such as a motor, and press the side ends of the sheets S stacked on the intermediate stacker portion 42. Lateral reference plates 72a and 72b are reference members that serve as a reference for the position of the sheets S in the X direction. The lateral reference plates 72a and 72b are disposed opposite lateral alignment plates 41a and 41b in the X direction.

### 1-4-1. Preparation Stage

As illustrated in FIG. 3A, the sheets S1 to S5 are conveyed toward the kick-out roller pair 29. The sheets S1 to S5 may be conveyed to the intermediate stacker portion 42 in a state in which a sheet Sj positioned lower protrudes further in the Y direction than a sheet Sj+1 positioned higher. Here, j is an index of the sheets S. Before the sheets S are stacked on the intermediate stacker portion 42, the longitudinal alignment plate 39 moves to a predetermined standby position in advance in accordance with the size of the sheets S to be aligned. The standby position is set such that the end position of the sheet S in the −Y direction is at a predetermined position regardless of the size of the sheets S. In other words, the standby position is a position at which the distance, in the Y direction, from the nip position of the kick-out roller pair 29 to the longitudinal alignment plate 39 is slightly longer than the length of the sheets in the Y direction. The lateral alignment plates 41a to 41c stand by in a position on the outer side, in the X direction, of the sheets S being conveyed, so as not to interfere with the conveyance of the sheets S.

### 1-4-2. Longitudinal Alignment Stage

FIG. 3B illustrates the trailing end of the first sheet S1 having exited the nip of the kick-out roller pair 29, and the leading end of the sheet S1 having reached the alignment roller 40. The sheet S1 is pressed against the longitudinal alignment plate 39, and is aligned according to the position of the longitudinal alignment plate 39. When the alignment roller 40 continues to rotate, the sheets S2 to S5 that reach the alignment roller 40 after the sheet S1 are pressed against the longitudinal alignment plate 39 in that order. As a result, the five sheets S1 to S5 are aligned in the Y direction (the longitudinal direction) according to the position of the longitudinal alignment plate 39.

### 1-4-3. Lateral Alignment Stage

FIG. 3C illustrates the alignment of the sheets S1 to S5 in the X direction (the lateral direction) having started after the alignment in the Y direction (the longitudinal direction) is complete. The lateral alignment plates 41a to 41c are driven in the X direction, which is the alignment direction, make contact with the side ends of the sheets S1 to S5, and press the sheets S1 to S5 toward the lateral reference plates 72a and 72b. The other side ends of the sheets S1 to S5 then make contact with contact surfaces 300 of the lateral reference plates 72a and 72b, and the sheets S1 to S5 are aligned in the X direction (the lateral direction) with the positions of the lateral reference plates 72a and 72b as a reference.

### 1-4-4. Adhesion Stage Thermal Compression Adhering Stage

FIG. 3D illustrates a state in which the alignment of the five sheets S1 to S5 in the X direction and the Y direction is complete. A target position in the alignment operations (an alignment position) is the position of the sheet bundle W when adhering processing (thermal compression adhering) is performed by the thermal compression adhering unit 51. As described above, the image forming apparatus 100 applies the adhesive toner Tn to the sheets S1 to S5 such that the sides on which the adhesive toner image is formed correspond to the side on which the thermal compression adhering unit 51 is located. However, if the sheet S1 is the cover of the booklet, the adhesive toner Tn may not be applied.

The thermal compression adhering unit 51 performs thermal compression adhering of the aligned sheets S1 to S5. During this time, the lateral alignment plates 41a to 41c retract in the −X direction. As a result, the intermediate stacker portion 42 enters a state in which the next plurality of sheets S can be accepted. The sheet bundle W constituted by sheets S6 to S10, formed by the buffer portion 80, is then stacked on the sheets S1 to S5.

The four stages described above are then repeated for the preceding sheet bundle W constituted by the adhered sheets S1 to S5 and the sheet bundle W constituted by the unadhered sheets S6 to S10. As a result, the sheets S1 to S10 are adhered in a state in which the sheets S1 to S10 are aligned with a high level of accuracy.

For example, the sheet bundle W is constituted by five sheets S. However, the number of sheets S constituting the sheet bundle W may be two, three, or the like. In other words, the number of sheets S included in the sheet bundle W may be any number less than or equal to the maximum number of sheets S that can be stacked in the buffer portion 80.

### 1-5. Thermal Compression Adhering Unit

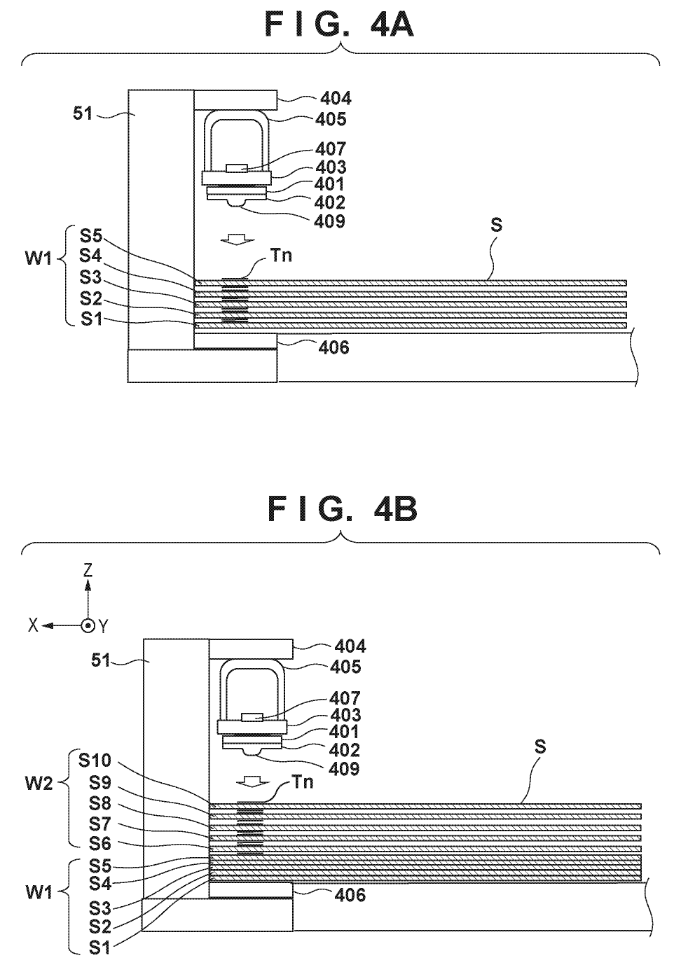

As illustrated in FIG. 4A, the thermal compression adhering unit 51 includes a heater 401 having a heating element as a heat source, and an aluminum heating plate 402 disposed thereon. The surface of the heating plate 402 may be coated. This is to improve the releasability with respect to the toner. The coating material is, for example, a copolymer of tetrafluoroethylene and perfluoroalkoxyethylene (PFA). The heater 401 is 1.0 mm long (thick) in the Z direction, for example. The heater 401 is 8.0 mm long (wide) in the X direction, for example. The heater 401 is 350 mm long in the Y direction, for example. The heating plate 402 is 1.5 mm thick, for example. The heater 401 is a ceramic heater, for example. The temperature of the heater 401 may be measured by a temperature sensor 407 and controlled by a control circuit such that the measured temperature becomes a target temperature. For example, a target temperature (e.g., 240°C) is set such that the surface temperature of a pressing portion 409 of the heating plate 402 is 200°C. Providing the heating plate 402 with the pressing portion 409 concentrates the heat and pressure of the thermal compression adhering unit 51 at a binding position of the sheet bundle W. This improves the heating and pressing efficiency. The elastic modulus of the pressing portion 409 is at least 1,000 Pa or more, but may be 10,000 Pa or more. This makes it difficult for the pressing portion 409 to deform even if thermal compression adhering is repeated.

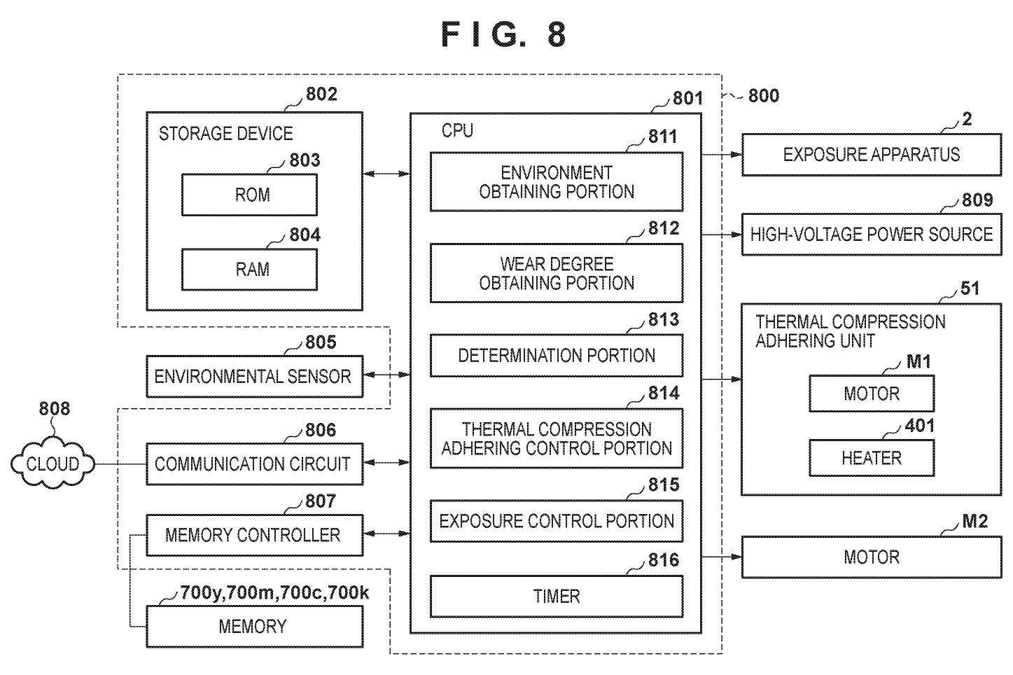

The heater 401 is supported by a heater support member 403 made of a resin. A pressing lever 404 is powered by a motor M1, illustrated in FIG. 8, to push the thermal compression adhering unit 51 in the −Z direction (the downward direction) and press the sheet bundle W. The pressure of the pressing lever 404 is transmitted to the pressing portion 409 through a metal stay 405, which is a rigid body. The pressure of the pressing lever 404 can be controlled according to the amount by which the pressing lever 404 is moved in the −Z direction (the downward direction). For example, the average contact pressure acting on the sheet bundle W is 0.2 MPa. A thermal compression adhering time T1 is 2.0 seconds, for example. The thermal compression adhering time may also be called a “contact time”, a “pressing time”, or a “heating time”.

A pressing plate 406 is a receiving member formed from an elastic material (e.g., silicone rubber). An elastic material is used because the pressing plate 406 is a member for receiving pressure in a stable manner. The elastic modulus of the pressing plate 406 is no more than 1,000 Pa, for example. The pressing plate 406 may also be provided with a PFA coating. The pressing plate 406 is 2.0 mm thick, for example. The thermal compression adhering unit 51 presses a sheet bundle W1 constituted by the sheets S1 to S5, and then separates from the sheet bundle W1. The sheets S1 to S5 in FIG. 4A are illustrated as first to fifth sheets S1 to S5 of a booklet serving as a finished product. The sheet S1 is the cover of the booklet. Accordingly, on the sheet S1, no image of the adhesive toner Tn, is formed on the bottom surface and an image is formed only on the top surface. Images of the adhesive toner Tn are formed on the top surfaces and the bottom surfaces of the second and subsequent sheets S2 to S5 of the booklet.

As illustrated in FIG. 4B, a sheet bundle W2 is stacked on the sheets S1 to S5 for which the thermal compression adhering is complete. The sheet bundle W2 is constituted by the sheets S6 to S10. The thermal compression adhering unit 51 performs the thermal compression adhering operation on the sheet bundle W2 stacked on the sheet bundle W1. A booklet constituted by a large number of sheets S is made as a result. Note that the number of sheets constituting the sheet bundle W1 may be different from the number of sheets constituting the sheet bundle W2.

The sheets S6 to S10 that are stacked later are included in the same booklet as the sheets S1 to S5. As such, an adhesive image containing the adhesive toner Tn is formed on the top surface and bottom surface of each of the sheets S6 to S10.

As one example, the post-processing apparatus 130 can make a booklet constituted by a maximum of 100 sheets S. When the booklet making is started, the buffer portion 80 buffers a maximum of five sheets S at a time to make sheet bundles W, and supplies the sheet bundles W to the intermediate stacker portion 42. The thermal compression adhering unit 51 performs the thermal compression adhering operations, which include a descending operation, a pressing operation, and an ascending operation, each time a sheet bundle W arrives. By repeating the buffering operation and the thermal compression adhering operations, a booklet is made efficiently without impairing the productivity of the image forming apparatus 100.

When the thermal compression adhering operations are completed for the sheet bundle W including the last page of the booklet in the intermediate stacker portion 42, the longitudinal alignment plate 39 moves from the standby position to the discharge position. In other words, the completed booklet is discharged by the longitudinal alignment plate 39 moving parallel toward the discharge port 46. The discharge port 46 is provided with the discharge rollers 38. Once the leading end of the booklet passes the discharge rollers 38 slightly, the longitudinal alignment plate 39 stops and then returns to the standby position. The discharge rollers 38 discharge the booklet to the lower tray 37.

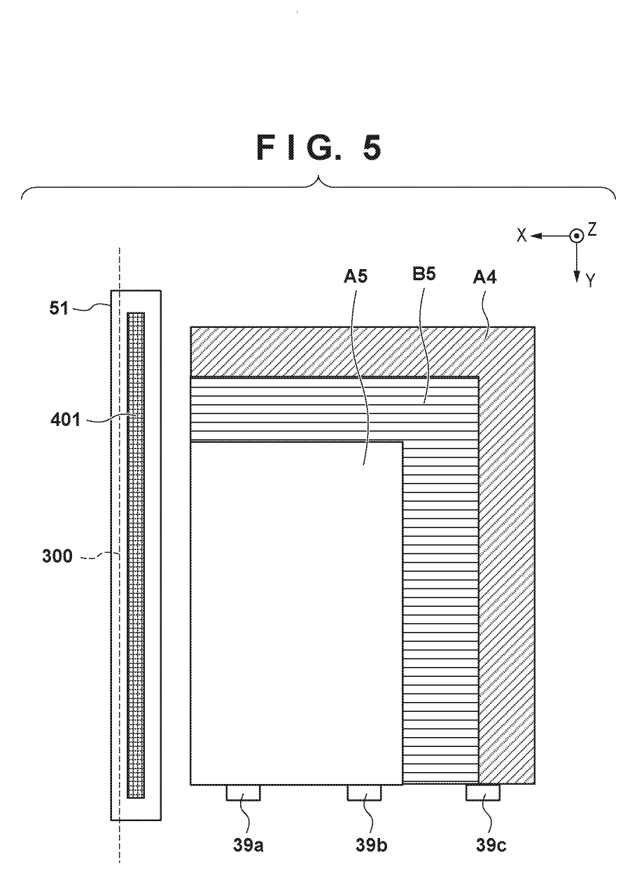

FIG. 5 is a diagram illustrating the positions of a plurality of sheets S, each having a different size, and the heater 401. The size of the sheet S is selected by the user as desired. Various sizes (e.g., A4, B5, and A5) can therefore be selected. In the X direction, the plurality of sheets S are aligned by a contact surface 300, regardless of the size of the sheets S. In the Y direction, the plurality of sheets S are aligned by the contact portions 39a to 39c, regardless of the size of the sheets S.

In this manner, the alignment positions of the plurality of sheets S subject to thermal compression adhering are the same regardless of the size of the sheets S. Accordingly, the installation position of the heater 401 is the same regardless of the size of the sheet S. This ensures adhesion at the ends of sheets S of a variety of sizes.

### 1-6. Adhesion Strength

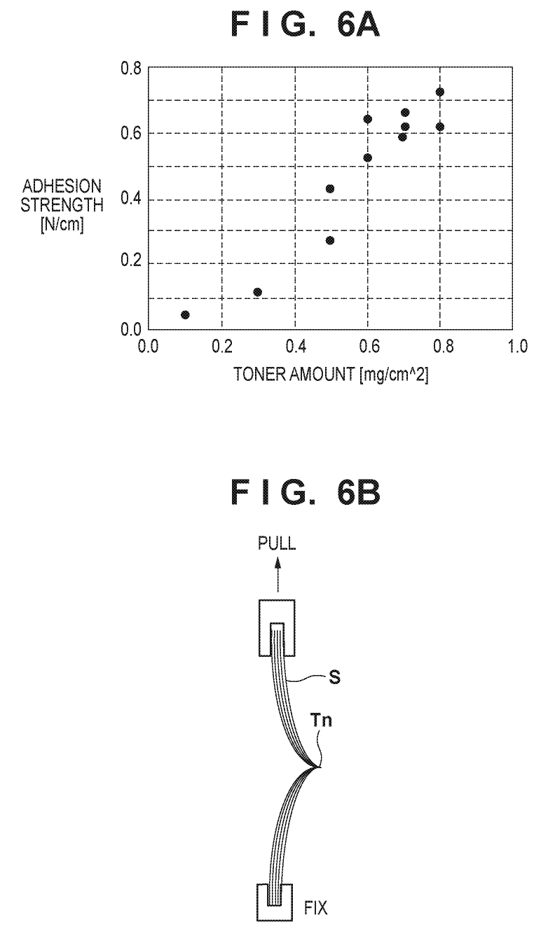

FIG. 6A illustrates a relationship between a toner amount of the adhesive toner Tn and an adhesion strength. The vertical axis represents the adhesion strength. The horizontal axis represents the toner amount. In a measurement experiment, a set temperature was set such that the surface temperature of the pressing portion 409 of the heating plate 402 was 200°C. The thermal compression adhering time of the thermal compression adhering unit 51 was set to 3 seconds. As illustrated in FIG. 6B, the adhesion strength corresponds to the peak value of a tensile force required to peel apart a plurality of the sheets S adhered by the adhesive toner Tn. The toner amount is the amount of the adhesive toner Tn forming the adhesive image before the thermal compression adhering processing is performed.

As illustrated in FIG. 6A, the adhesion strength is correlated with the toner amount. In other words, as the toner amount increases, so too does the adhesion strength. Meanwhile, any adhesion strength of at least about 0.5 N/cm was found to be sufficient for a completed booklet. However, this numerical value is merely one example. The adhesion strength of 0.5 N/cm was confirmed using plain paper known as “Office 70”, manufactured by Canon Marketing Japan Inc., as the sheets S. Accordingly, the appropriate amount of adhesion depends on the type or brand of the sheet S, or the purpose of the booklet.

### 1-7. Process Cartridge

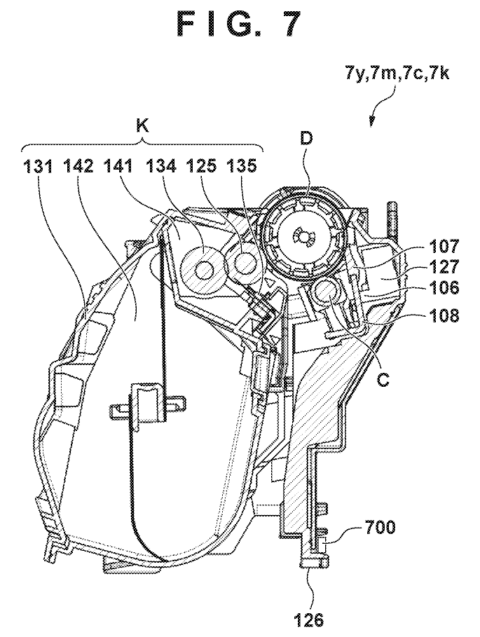

FIG. 7 illustrates the process cartridges 7y, 7m, 7c, and 7k in detail. The process cartridges 7y, 7m, 7c, and 7k have the same structure. Accordingly, the process cartridges 7y, 7m, 7c, and 7k will be referred to as process cartridges 7.

The process cartridge 7 includes a cleaning unit 126 and a developing apparatus K. The cleaning unit 126 includes a photosensitive drum D, a charging roller C, and a cleaning member 106. The developing apparatus K includes a developing roller 125 that rotates in contact with the photosensitive drum D, a developing frame 131 that supports the developing roller 125, and a developing blade 135. The developing frame 131 includes a developing chamber 141 and a toner holding chamber 142.

The charging roller C and the cleaning member 106 are disposed in the periphery of the photosensitive drum D. The cleaning member 106 includes a rubber blade 107, which is a blade-shaped elastic member, and a support member 108. The tip of the rubber blade 107 contacts the photosensitive drum D against the rotation direction of the photosensitive drum D. Residual toner removed from the surface of the photosensitive drum D by the cleaning member 106 is collected in a removed toner chamber 127.

The charging roller C is rotatably attached to the cleaning unit 126 by a bearing. The charging roller C is pressed toward the photosensitive drum D and rotates along with the rotation of the photosensitive drum D. Here, a charging voltage is applied to a metal core of the charging roller C from a high-voltage power source. As a result, the surface of the photosensitive drum D is charged so that a surface potential of the photosensitive drum D takes on a uniform dark area potential Vd.

An electrostatic latent image corresponding to the image data is formed by emitting laser beams from the exposure apparatus 2. The charge on the exposed surface is dissipated by carriers from a carrier generation layer, and the potential of the exposed surface therefore decreases. As a result, the potential of the exposed surface takes on a light part potential Vl. The potential of the unexposed surface is the dark area potential Vd.

A toner supply roller 134 and the developing blade 135 are disposed in the periphery of the developing roller 125. The toner supply roller 134 rotates in contact with the developing roller 125. Toner supplied to the developing chamber 141 from the toner holding chamber 142 is then supplied to the developing roller 125 by the toner supply roller 134. The developing blade 135 regulates the thickness of the toner layer formed on the developing roller 125.

The developing roller 125 has a metal core and an elastic layer. The elastic layer is disposed around the metal core. The elastic layer is, for example, a conductive elastic rubber layer having a predetermined volume resistance. The elastic layer of the developing roller 125 has a base layer and a surface layer. The base layer is formed of silicone rubber, for example. The surface layer is formed of urethane rubber, for example. Urethane bead particles may be dispersed throughout the urethane rubber of the surface layer. The developing roller 125 and the photosensitive drum D are disposed so as to face each other and be in contact with each other. The developing roller 125 and the photosensitive drum D rotate such that the surface of the developing roller 125 and the surface of the photosensitive drum D move in the same direction at the contact portion. A developing voltage Vdc is applied to the metal core of the developing roller 125 from a high-voltage power source. As a result, toner negatively charged by frictional electrification adheres to the part of the surface of the photosensitive drum D that is at the light part potential Vl. This forms an electrostatic latent image. The difference between the developing voltage Vdc and the light part potential Vl is called a “development contrast”. The difference between the developing voltage Vdc and the dark area potential Vd is called a “back contrast”. The amount of toner adhering to the photosensitive drum D is controlled by adjusting the magnitudes of the development contrast and the back contrast. This controls the image density, line width, fogging, and the like. “Fogging” is a phenomenon in which a small amount of toner adheres to unexposed areas where toner is not intended to adhere.

The developing blade 135 is disposed below the developing roller 125 and is in contact with the developing roller 125. The developing blade 135 regulates the coating amount of the toner supplied by the toner supply roller 134, and also imparts an electric charge on the toner. The developing blade 135 has, for example, a flexible plate member and a support member that anchors the plate member. The plate member may be formed by machining stainless steel into a plate spring shape. The plate member is 80 μm thick, for example. The toner supplied to the developing roller 125 is charged as a result of the friction between the developing blade 135 and the developing roller 125. This also regulates the thickness of the toner layer. A predetermined voltage may be applied to the developing blade 135. This stabilizes the toner layer.

The toner supply roller 134 is in contact with the developing roller 125. The toner supply roller 134 rotates under drive force received from a motor. The toner supply roller 134 and the developing roller 125 rotate in opposite directions at a nip portion. Residual toner on the developing roller 125 is collected, and toner is supplied to the developing roller 125, as a result. The amount of residual toner collected and the amount of toner supplied are adjusted by adjusting the difference between the potentials of the toner supply roller 134 and the developing roller 125.

The process cartridge 7 has a non-volatile memory 700 as a storage medium. The memory 700 stores the number of rotations of the photosensitive drum D, the number of rotations of the developing roller 125, the remaining toner amount, control information (e.g., tables, formulas, and program modules), and the like. Furthermore, the memory 700 stores identification information that can specify the type of the process cartridge 7, such as a serial number of the process cartridge 7 and model information indicating the model of the process cartridge 7.

### 1-8. Control System

FIG. 8 illustrates a controller 800 of the image forming system 1. A CPU 801 implements various functions by executing control programs stored in a storage device 802. Some or all of these functions may be implemented by hardware circuitry such as application-specific integrated circuits (ASICs) or field-programmable gate arrays (FPGAs). The storage device 802 is a storage device that can include a read-only memory (ROM) 803, a random access memory (RAM) 804, a hard disk drive (HDD), a solid-state drive (SSD), and the like.

A high-voltage power source 809 generates a charging bias (a charging voltage) supplied to the charging roller C and a developing bias (a developing voltage) supplied to the developing roller of the developing apparatus K. The CPU 801 adjusts the maximum density of the toner image by adjusting the charging bias or the developing bias.

The thermal compression adhering unit 51 includes the motor M1 that drives the pressing lever 404, and the heater 401. A motor M2 rotationally drives a rotating body such as the feed roller 81, for example.

The CPU 801 implements a plurality of functions in accordance with control programs stored in the ROM 803. An environment obtaining portion 811 uses an environmental sensor 805 to obtain environmental conditions (e.g., temperature, humidity) of the environment in which the image forming system 1 is installed. A wear degree obtaining portion 812 obtains a wear state of the process cartridge 7 (e.g., the remaining toner amount, a cumulative operation time of the process cartridge 7, a cumulative number of rotations of the developing roller 125, and a cumulative number of rotations of the photosensitive drum D). The cumulative operation time may also be called a “cumulative usage time”. A determination portion 813 determines booklet making conditions using at least one of the environmental conditions and the wear state. The booklet making conditions include at least one of image forming conditions applied to the adhesive toner Tn (the adhesive layer; the adhesive image) in the image forming apparatus 100, and thermal compression adhering conditions applied to the thermal compression adhering unit 51 (e.g., a heating temperature, an applied pressure, and a thermal compression adhering time). The storage device 802 or the memory 700 may store initial values (reference values) for the booklet making conditions. A determination portion 813 may correct the initial values using at least one of the environmental conditions and the wear state. A thermal compression adhering control portion 814 controls the thermal compression adhering unit 51 using the thermal compression adhering conditions determined by the determination portion 813. The CPU 801 controls the image forming apparatus 100 using the image forming conditions determined by the determination portion 813. An exposure control portion 815, which will be described in detail in a second embodiment, controls the exposure apparatus 2 using exposure conditions determined by the determination portion 813. A timer 816 is used to control the thermal compression adhering time.

The determination portion 813 can read out the information stored in the memories 700y, 700m, 700c, and 700k, write information into the memories 700y, 700m, 700c, and 700k, and the like through a memory controller 807. Note that the memories 700y, 700m, 700c, and 700k are mounted in the process cartridges 7y, 7m, 7c, and 7k, respectively. The memories 700y, 700m, 700c, and 700k may store control information used to determine image forming conditions or thermal compression adhering conditions applied to the adhesive image based on at least one of the wear state and the environmental conditions.

The CPU 801 is communicably connected to a cloud 808 by a communication circuit 806. The determination portion 813 may access the cloud 808 through the communication circuit 806 to obtain the control information used to determine the image forming conditions or thermal compression adhering conditions applied to the adhesive image based on at least one of the wear state and the environmental conditions. The determination portion 813 may transmit at least one of the wear state and the environmental conditions to the cloud 808, cause the cloud 808 to determine the image forming conditions or thermal compression adhering conditions applied to the adhesive image, and receive the image forming conditions or thermal compression adhering conditions. The cloud 808 may include, for example, network storage that stores the control information, or a server computer that determines the image forming conditions or the thermal compression adhering conditions. The cloud 808 may be referred as a cloud computer, a cloud server, a cloud computer system.

### 1-9. Control Information

An image prepared as desired by a user (a user image) and an adhesive image may be formed by the same process cartridge 7 at the same time. However, depending on the state of the process cartridge 7 (the wear state and the environmental conditions), the control conditions to be applied to the user image may not match the control conditions to be applied to the adhesive image.

When the running distance of the developing roller 125 is high and the process cartridge 7 is used in a low-temperature and low-humidity environment, toner regulation problems may arise. When the running distance of the developing roller 125 increases in a low-temperature and low-humidity environment, a current flows to the developing roller 125 and the resistance value of the developing roller 125 rises (energization deterioration). When the resistance value of the developing roller 125 rises, the charge held by the toner on the developing roller 125 is more difficult to eliminate, causing the toner to become more charged. A method that increases the back contrast is one measure against regulation problems. This can suppress the occurrence of fogging caused by poor regulation of the toner. However, as the back contrast increases, the development contrast decreases. In other words, the toner amount in the toner image decreases. At this time, the toner amount in the adhesive image formed along with the user image also decreases. This causes a drop in the adhesion strength of the booklet.

The process cartridge 7 used to form the user image may be different from the process cartridge 7 used to form the adhesive image. In other words, the image forming apparatus 100 may have a fifth process cartridge 7 prepared specifically for the adhesive toner Tn. In this case, the CPU 801 can optimize the image forming conditions of the user image and the image forming conditions of the adhesive image separately. However, this requires the fifth process cartridge 7, which increases the size of the image forming apparatus 100.

After forming the user image, the same process cartridge 7 may form the adhesive image in a separate process. This, however, will cause the productivity of booklets to drop.

When the same process cartridge 7 is used to form the user image and the adhesive image at the same time, ensuring the adhesion strength may be prioritized. In other words, the temperature of the heater 401 may be pre-set to a high temperature, or the thermal compression adhering time may be increased in advance, to ensure sufficient adhesion strength. However, with this method, the amount of toner will become excessive in adhesive images where the toner amount is already sufficient, which increases the amount of toner consumed. Furthermore, increasing the thermal compression adhering time reduces the productivity of booklets. The amount of power consumed by the image forming system 1 also increases.

Accordingly, what is needed is a method for determining the image forming conditions suited to the user image and the image forming conditions or the thermal compression adhering conditions suited to the adhesive image in accordance with the wear state or the environmental conditions of the image forming portion 10. The CPU 801 can determine image forming conditions suited to the user image in accordance with the wear state or the environmental conditions of the process cartridge 7. Accordingly, a method for determining the image forming conditions or the thermal compression adhering conditions suited to the adhesive image in accordance with the wear state or the environmental conditions of the process cartridge 7 will be described in detail.

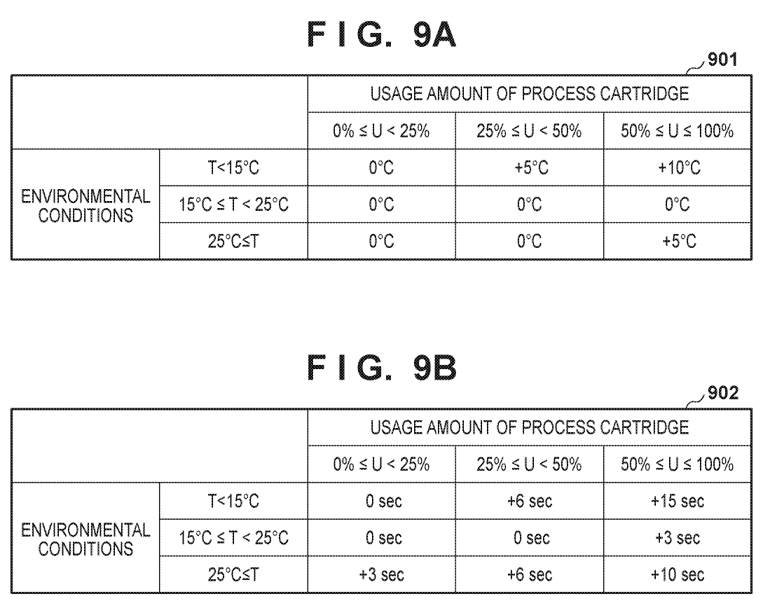

FIG. 9A illustrates a correction table 901 used to correct the heating temperature of the heater 401. The correction table 901 stores correction values for the heating temperature corresponding to combinations of the usage amount (the wear state) and the environmental conditions (the ambient temperature) of the process cartridge 7. FIG. 9B illustrates a correction table 902 used to correct the thermal compression adhering time of the thermal compression adhering unit 51. The correction table 902 stores correction values for the thermal compression adhering time corresponding to combinations of the usage amount (the wear state) and the environmental conditions (the ambient temperature) of the process cartridge 7. Although stored in the memory 700 here, the correction tables 901 and 902 may be stored in the cloud 808.

The usage amount of the process cartridge 7 may be an evaluation value determined according to a combination of a cumulative number of rotations (or a cumulative rotation time) of the developing roller 125 and a remaining toner amount (a cumulative consumption amount), for example. The CPU 801 (the determination portion 813) obtains a combination of the cumulative number of rotations of the developing roller 125 and the remaining toner amount from the memory 700, and refers to the correction tables 901 and 902 based on that combination. Through this, the determination portion 813 determines an evaluation value indicating the wear state of the process cartridge 7(a usage rate). Note that the memory 700 or the storage device 802 may store tables, formulas, or program modules that output an evaluation value upon inputting a combination of the cumulative number of rotations of the developing roller 125 and the remaining toner amount. The correction tables 901 and 902 may also be implemented by formulas or program modules.

As indicated in the correction tables 901 and 902, the thermal compression adhering conditions may be changed depending on the environmental conditions detected by the environmental sensor 805. The environmental conditions change the degree of agglomeration of the toner, the charge level, and the resistance value or the hardness of the members in the process cartridge 7. The appropriate developing voltage therefore changes in accordance with the environmental conditions. The CPU 801 adjusts the image forming conditions in accordance with the environmental conditions such that the user image is formed appropriately. Accordingly, the image forming conditions of the adhesive image are also adjusted. If the adhesion strength decreases as a result of the image forming conditions being adjusted, the CPU 801 adjusts the thermal compression adhering conditions to compensate for the decrease in the adhesion strength.

The correction table 901 illustrated in FIG. 9A and the correction table 902 illustrated in FIG. 9B are merely examples. The storage viscoelasticity of the toner with which the process cartridge 7 is filled may be employed as the usage amount of the process cartridge 7, serving as a parameter affecting the adhesion strength. The surface roughness of the developing roller 125 and the contact state between the developing roller 125 and the developing blade 135 may be employed as parameters that affect the toner amount of the adhesive image. The toner amount in the adhesive image can be estimated from the structure of the process cartridge 7 and the image forming conditions determined for the user image. Accordingly, a table, formula, or program module for determining the correction values for the thermal compression adhering conditions from the image forming conditions determined for the user image may be stored in the memory 700. This makes it possible to determine more appropriate thermal compression adhering conditions (temperature, pressure, and time) in accordance with the individual characteristics of the process cartridge 7.

The correction values are not limited to positive values. The correction values may be negative values. Negative values are useful when the toner has been modified to enhance the adhesion strength. In other words, negative values can reduce the heating temperature and the thermal compression adhering time. This reduces the power and time required to make booklets.

### 1-10. Flowchart

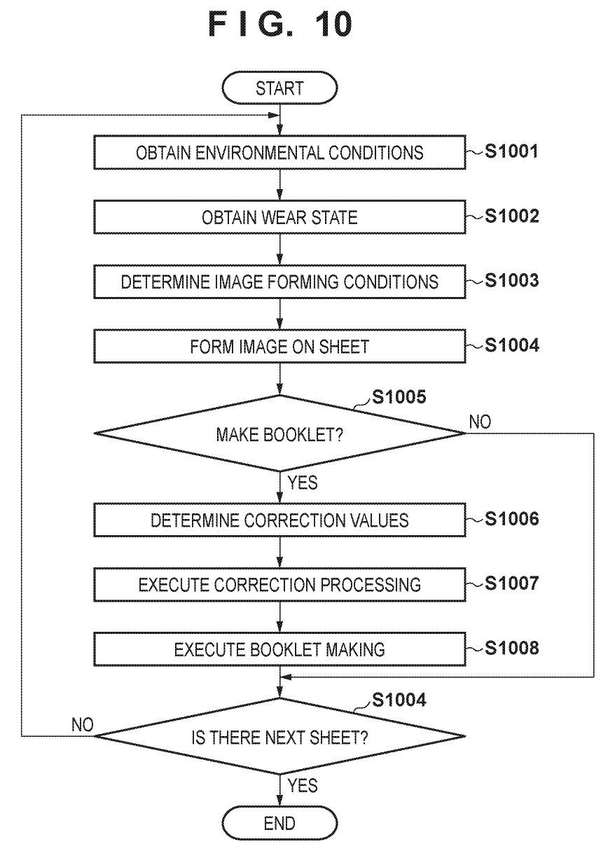

FIG. 10 illustrates a control method for the image forming system 1. The CPU 801 executes the following processing according to a control program. The CPU 801 starts the control method upon receiving a print job from a host computer or the like.

In step S1001, the CPU 801 (the environment obtaining portion 811) obtains the environmental conditions of the image forming system 1. For example, the environment obtaining portion 811 detects the ambient temperature using the environmental sensor 805.

In step S1002, the CPU 801 (the wear degree obtaining portion 812) obtains the wear state of the process cartridge 7. For example, the wear degree obtaining portion 812 reads out the usage amount of the process cartridge 7 from the memory 700 provided in the process cartridge 7.

In step S1003, the CPU 801 (the determination portion 813) determines the image forming conditions based on the environmental conditions and the wear state. In the first embodiment, the image forming conditions are image forming conditions applied in common to both the user image and the adhesive image.

In step S1004, the CPU 801 forms images on a sheet S by controlling the image forming apparatus 100 in accordance with the image forming conditions. The user image and the adhesive image are formed on the sheet S as a result.

In step S1005, the CPU 801 determines whether to make a booklet based on a result of analyzing the print job. If a booklet is not instructed to be made, the CPU 801 skips steps S1006 to S1008 and moves the sequence to step S1009. If a booklet is instructed to be made but the number of sheets S conveyed to the intermediate stacker portion 42 is less than a predetermined number of sheets, the CPU 801 moves the sequence from step S1005 to step S1009. If a booklet is instructed to be made and the number of sheets S conveyed to the intermediate stacker portion 42 is the predetermined number of sheets, the CPU 801 moves the sequence from step S1005 to step S1006. The predetermined number of sheets is basically the number of sheets S that form a single sheet bundle. The number of sheets S that form the last sheet bundle may be less than the predetermined number of sheets. The CPU 801 also moves the sequence from step S1005 to step S1006 when the last sheet bundle is conveyed to the intermediate stacker portion 42.

In step S1006, the CPU 801 (the determination portion 813) determines the correction values for the thermal compression adhering conditions based on the environmental conditions and the wear state. The determination portion 813 reads out the correction value for the heating temperature with reference to the correction table 901 based on the environmental conditions and the wear state. The determination portion 813 reads out the correction value for the thermal compression adhering time with reference to the correction table 902 based on the environmental conditions and the wear state.

In step S1007, the CPU 801 (the thermal compression adhering control portion 814) executes correction processing based on the correction values determined. The thermal compression adhering control portion 814 corrects the heating temperature using the correction value determined by the determination portion 813. The thermal compression adhering control portion 814 corrects the thermal compression adhering time using the correction value determined by the determination portion 813. The correction values may be values which are added to the values to be corrected, or may be coefficients multiplied with the values to be corrected.

In step S1008, the CPU 801 executes booklet making by controlling the post-processing apparatus 130. The thermal compression adhering control portion 814 controls the thermal compression adhering unit 51 to perform the thermal compression adhering processing on the booklet using the thermal compression adhering conditions corrected as necessary.

In step S1009, the CPU 801 analyzes the print job and determines whether a next sheet S on which an image is to be formed is present. If a next sheet S is present, the CPU 801 returns the sequence from step S1009 to step S1001, and executes steps S1001 to step S1009 for the next sheet S. If a next sheet S is not present, the CPU 801 ends the booklet making.

### 1-11. Effects

To confirm the effects of the first embodiment, an experiment was performed in which the ambient temperature was 15°C and the ambient humidity was 10% RH. A horizontal line with an image ratio of 1% was used as the user image. The user image and the adhesive image were continuously formed on a plurality of the sheets S. The adhesion strength was measured when the usage amount of the process cartridge 7 was 0%, 40%, and 80%. A booklet was formed by adhering 50 sheets S using an adhesive layer. A plurality of booklets were repeatedly made during the experiment. The reference value of the heating temperature of the pressing portion 409 was 200℃. The reference value of the thermal compression adhering time of the thermal compression adhering unit 51 was 3 seconds.

### 1-11-1. Comparative Example

In a comparative example, the thermal compression adhering conditions were not corrected according to the usage amount of the process cartridge 7. In other words, in the comparative example, the reference values (initial values) of the thermal compression adhering conditions were used throughout.

### 1-11-2. Experiment Results

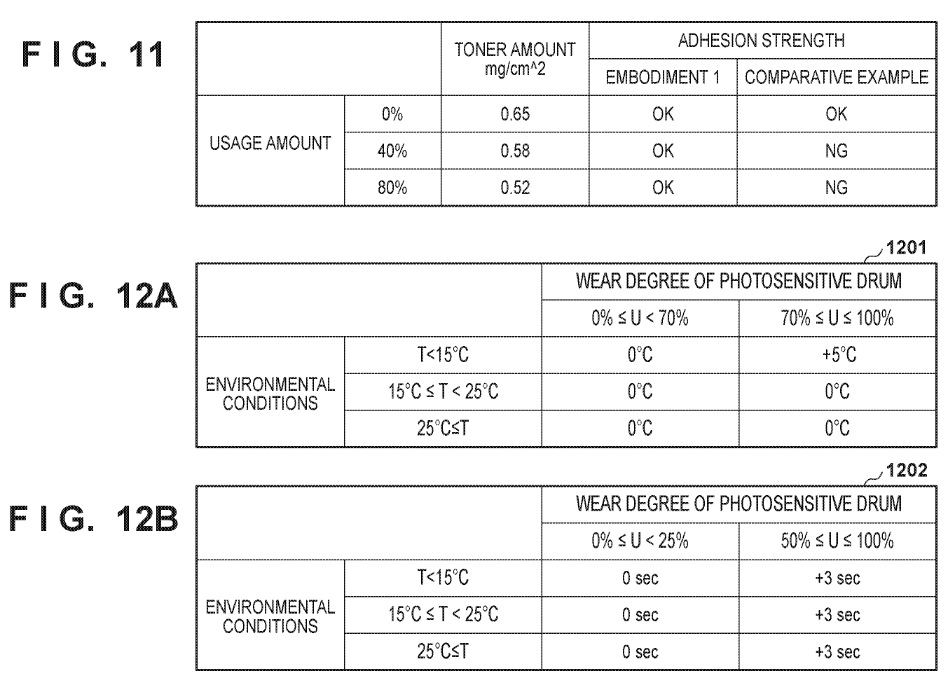

FIG. 11 illustrates experiment results from the first embodiment and experiment results from the comparative example. “OK” indicates that the adhesion strength was at least 0.5 N/cm. “NG” indicates that the adhesion strength was less than 0.5 N/cm.

In the comparative example, when the usage amount of the process cartridge 7 was low, good adhesion strength was achieved even with a short thermal compression adhering time. However, as the usage amount of the process cartridge 7 increased, the amount of toner on the sheet S decreased, and sufficient adhesion strength was no longer achieved.

In the first embodiment, sufficient adhesion strength was achieved regardless of the usage amount of the process cartridge 7. When the usage amount reached 40%, the surface temperature of the pressing portion 409 of the heating plate 402 was corrected to 205°C. The thermal compression adhering time was corrected to 9 seconds. When the usage amount reached 80%, the surface temperature of the pressing portion 409 was corrected to 210°C. The thermal compression adhering time was corrected to 18 seconds.

According to the first embodiment, the booklet making conditions are automatically switched according to the environmental conditions and the wear state. This ensures good adhesion strength is achieved regardless of the wear state of the process cartridge 7. This also makes it less likely that users will be required to perform complex and cumbersome operations. Note also that because the thermal compression adhering conditions are increased as necessary, it is unlikely that the booklet making time will be prolonged needlessly. Furthermore, because the heating temperature is increased as necessary, it is unlikely that more power will be consumed needlessly.

### 1-12. Variations

The memory 700 may store an address table. The address table stores addresses associated with at least one of the environmental conditions and the wear state. The storage device 802 stores a correction table in a storage region associated with each different address. The CPU 801 obtains the address associated with at least one of the environmental conditions and the wear state from the memory 700, and refers to the storage device 802 based on the address. This makes it possible to obtain, from the storage device 802, a correction table for obtaining correction values associated with at least one of the environmental conditions and the wear state. In this case, the memory 700 stores the address, so the correction table need not be stored. This makes it possible to reduce the storage capacity of the memory 700. There is a further advantage in that when the correction table is updated, the address stored in the memory 700 does not need to be updated. In other words, updating the correction table stored in the storage device 802 is sufficient.

The CPU 801 may adjust the booklet making conditions in accordance with toner information indicating the type (e.g., the components) or the like of the toner contained in the process cartridge 7.

### 2. Second Embodiment

In the second embodiment, a degree of degradation of the photosensitive drum D is used as the wear state. As illustrated in FIG. 2B, when a large number of booklets are adhered by causing the edges to adhere, part of the surface of the photosensitive drum D may deteriorate more than the surrounding parts. In other words, when adhesive images are repeatedly formed on part of the surface of the photosensitive drum D, the carrier generation layer in that part deteriorates. The amount of carriers generated decreases as a result, and the light part potential Vl drops below a target potential. The development contrast also drops below a target value, causing the toner amount in the adhesive image, and thus the adhesion strength, to drop.

FIG. 12A illustrates a heating temperature correction table 1201 according to the second embodiment. The correction table 1201 holds heating temperature correction values corresponding to combinations of environmental conditions and wear degrees of the photosensitive drum D. FIG. 12B illustrates a thermal compression adhering time correction table 1202 according to the second embodiment. The correction table 1202 holds thermal compression adhering time correction values corresponding to combinations of environmental conditions and wear degrees of the photosensitive drum D.

The CPU 801 counts the number of times an adhesive image has been formed on the photosensitive drum D (the cumulative usage count), and stores the count value in a non-volatile region of the storage device 802. The count value indicates the wear degree of the photosensitive drum D due to adhesive images being repeatedly formed thereon. The wear degree may be calculated from the number of rotations of the photosensitive drum D when booklets are made by adhering the corners thereof, for example. “100%” indicates a number of rotations equivalent to a guaranteed lifespan for booklet making assumed by design for the photosensitive drum D.

In step S1006, the CPU 801 refers to the correction table 1201 based on the combination of the wear degree of the photosensitive drum D and the environmental conditions, and determines the correction value for the heating temperature. The CPU 801 also refers to the correction table 1202 based on the combination of the wear degree of the photosensitive drum D and the environmental conditions, and determines the correction value for the thermal compression adhering time.

In step S1007, the CPU 801 corrects the heating temperature using the correction value obtained from the correction table 1201. In other words, the heating temperature is determined by adding the correction value to the reference value. The CPU 801 also corrects the thermal compression adhering time using the correction value obtained from the correction table 1202. In other words, the thermal compression adhering time is determined by adding the correction value to the reference value.

As with the correction tables 901 and 902, the correction tables 1201 and 1202 may be obtained from the cloud 808. Alternatively, the correction processing may be executed in the cloud 808.

The CPU 801 may add both the correction value obtained from the correction table 901 and the correction value obtained from the correction table 1201 to the reference value for the heating temperature. The CPU 801 may also add both the correction value obtained from the correction table 902 and the correction value obtained from the correction table 1202 to the reference value for the thermal compression adhering time.

According to the second embodiment, the booklet making conditions are corrected according to the wear state of the photosensitive drum D. Doing so improves the adhesion strength of the booklet when the photosensitive drum D has become worn.

### 3. Third Embodiment

A third embodiment will describe a method for controlling a laser beam intensity for forming an adhesive image in accordance with the wear degree of the photosensitive drum D caused by the formation of adhesive images. This ensures the adhesion strength for booklets is maintained even when the carrier generation layer of the photosensitive drum D has deteriorated from making booklets.

### 3-1. Exposure Apparatus

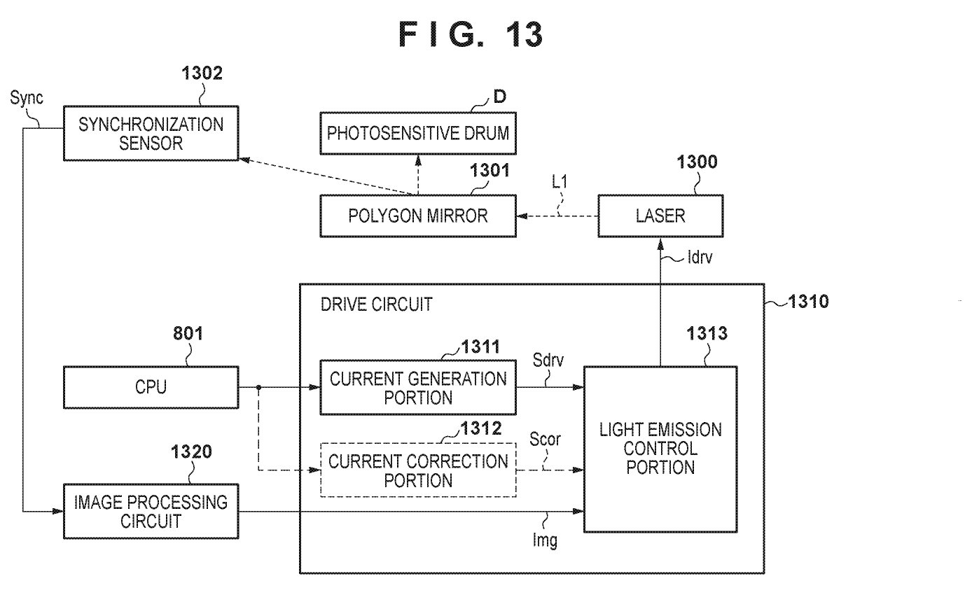

FIG. 13 illustrates a drive circuit 1310 installed in the exposure apparatus 2. The exposure apparatus 2 includes the drive circuit 1310, a laser 1300, a polygon mirror 1301, and a synchronization sensor 1302. The laser 1300 emits light in response to drive current Idrv supplied from the drive circuit 1310. A laser beam L1 is deflected by the rotating polygon mirror 1301, and scans the synchronization sensor 1302 and the surface of the photosensitive drum D. In other words, the synchronization sensor 1302 outputs a synchronization signal Sync each time the laser beam L1 scans the surface of the photosensitive drum D once parallel to a main scanning direction. An image processing circuit 1320 outputs image data Img, corresponding to one main scanning line, to a light emission control portion 1313, each time the synchronization signal Sync is input. The light emission control portion 1313 modulates the drive current Idrv corresponding to a reference light intensity set by the CPU 801, according to the image data Img. The laser 1300 repeatedly turns on and off as a result.

The CPU 801 sets the reference light intensity amount in a current generation portion 1311 through serial communication. The current generation portion 1311 supplies a setting signal Sdrv based on the reference light intensity to the light emission control portion 1313. The light emission control portion 1313 supplies the drive current Idrv to the laser 1300 such that the laser 1300 emits light at a light intensity corresponding to the setting signal Sdrv.

In the third embodiment, a current correction portion 1312 is further added. The CPU 801 sets, in the current correction portion 1312, a correction value based on the wear degree at a specific main scanning position on the surface of the photosensitive drum D. The current correction portion 1312 can identify the current main scanning position in synchronization with the synchronization signal Sync. The current correction portion 1312 outputs a correction signal Scor to the light emission control portion 1313 when the current main scanning position is a main scanning position that requires light intensity correction. The light emission control portion 1313 corrects the drive current Idrv based on the correction signal Scor. Accordingly, the light intensity of the laser beam L1 is increased temporarily during a period in which the laser beam L1 is forming the adhesive image (a main scanning range).

### 3-2. Exposure Control

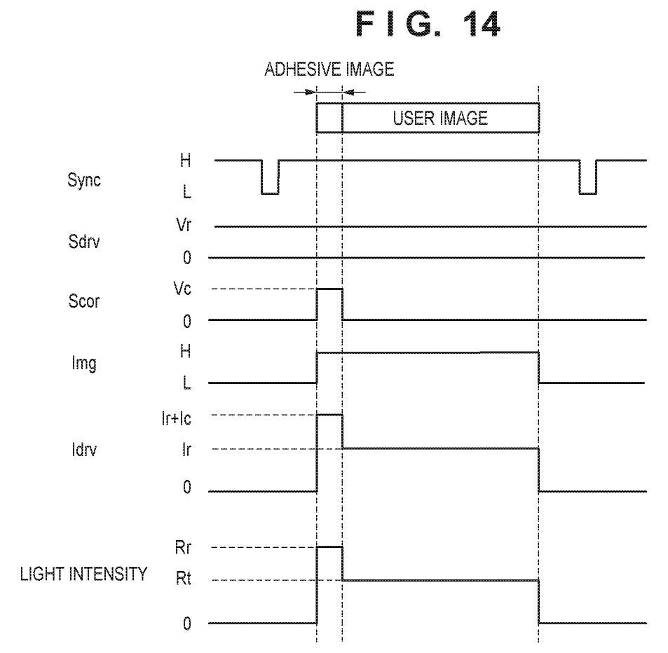

FIG. 14 is a sequence chart illustrating exposure control. The exposure light intensity in the main scanning direction when an adhesive image is formed at the long side edge, as illustrated in FIG. 5A, is indicated here. The synchronization signal Sync changes from High to Low during a period in which the laser beam L1 traverses the synchronization sensor 1302.

The drive current Idrv when the voltage of the setting signal Sdrv is Vr is Ir. The voltage of the correction signal Scor is set from 0 V to Vc when a predetermined time has passed after the falling edge of the synchronization signal Sync. Correction current Ic based on the voltage Vc is therefore generated. The drive current Idrv flows to the laser 1300 during the period when the image data Img is High. The drive current Idrv is the sum of the current Ir and the current Ic in the period where the voltage of the correction signal Scor is Vc. The drive current Idrv is the current Ir in the period where the correction signal Scor is 0 V. The light intensity of the laser beam L1 when scanning the adhesive image is a light intensity Rr, which corresponds to the current Ir + Ic. The amount of toner with which the adhesive image is formed is increased as a result. The light intensity of the laser beam L1 when scanning the user image is a light intensity Rt, which corresponds to the current Ir.

In this manner, the CPU 801 can set the width of the adhesive image according to the image data Img and the output timing of the correction signal Scor. The exposure light intensity for the adhesive image is changed by changing the voltage Vr and the voltage Vc. The exposure light intensity of the user image and the exposure light intensity of the adhesive image can be changed independently.

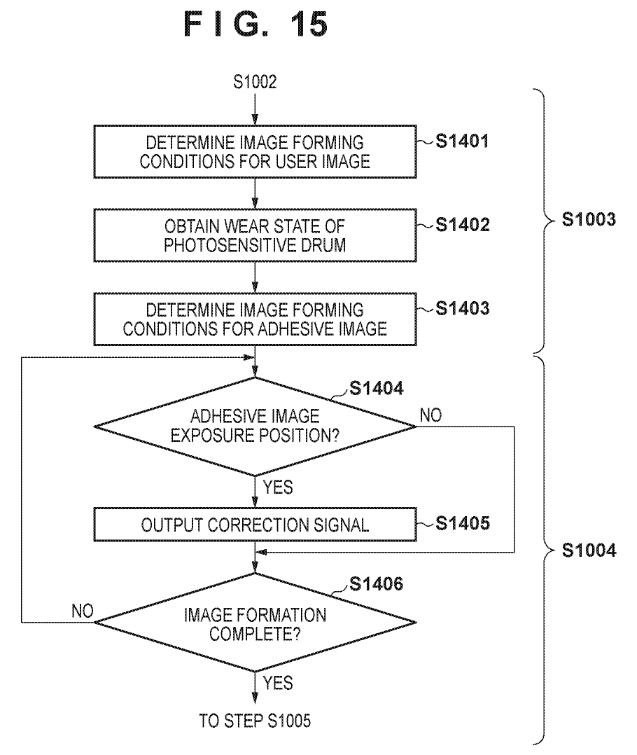

FIG. 15 is a flowchart illustrating the third embodiment. The flowchart of the third embodiment corresponds to the flowcharts of the first and second embodiments, with steps S1003 and S1004 changed.

In step S1401, the CPU 801 (the determination portion 813) determines the image forming conditions for the user image based on the environmental conditions obtained in step S1001 and the wear state obtained in step S1002.

In step S1402, the CPU 801 (the wear degree obtaining portion 812) obtains the wear state of the photosensitive drum D. This wear state is a wear state of the carrier generation layer in a specific surface region (main scanning region) resulting from repeatedly generating adhesive images.

In step S1403, the CPU 801 (the determination portion 813) determines the image forming conditions for the adhesive image (e.g., the correction value Vc) based on the wear state of the photosensitive drum D. As suggested in FIG. 12A, the correction value Vc may be used when the wear degree of the photosensitive drum D is at least 70% and at most 100%. The correction value is 0 V when the wear degree of the photosensitive drum D is less than 70%. Note that as suggested in the first and second embodiments, a correction table associating wear degrees of the photosensitive drum D with correction values may be stored in the memory 700, the storage device 802, or the cloud 808. The determination portion 813 may determine the correction value by referring to the correction table based on the wear degree of the photosensitive drum D.

In step S1404, the CPU 801 (the exposure control portion 815) determines whether the current exposure position is the exposure position of the adhesive image based on the count value of the synchronization signal Sync. The count value of the synchronization signal Sync indicates the main scanning position. The CPU 801 also knows the main scanning position at which the adhesive image is formed. Accordingly, the exposure control portion 815 can determine whether the current exposure position is the exposure position of the adhesive image. If the current exposure position is not the exposure position of the adhesive image, no correction is necessary, and thus the CPU 801 moves the sequence from step S1404 to step S1406. However, if the current exposure position is the exposure position of the adhesive image, the CPU 801 moves the sequence from step S1404 to step S1405.

In step S1405, the CPU 801 (the exposure control portion 815) outputs the correction signal Scor to the drive circuit 1310. The voltage of the correction signal Scor is set to the correction value Vc or 0 V.

In step S1406, the CPU 801 determines whether image formation is complete for a single sheet S. If image formation is not complete for a single sheet S, the CPU 801 returns the sequence to step S1404 from step S1406 to render the next main scanning line. Once the image formation is complete, the CPU 801 moves the sequence from step S1406 to step S1005.

Increasing the exposure light intensity in accordance with the wear degree in the specific surface region of the photosensitive drum D in this manner makes it possible to increase the toner amount of the adhesive image. This further stabilizes the adhesion strength.

According to the third embodiment, the exposure light intensity for generating the adhesive image is increased as the wear degree of the photosensitive drum D increases. The wear degree of the photosensitive drum D will therefore not increase unnecessarily.

### 4. Other Variations

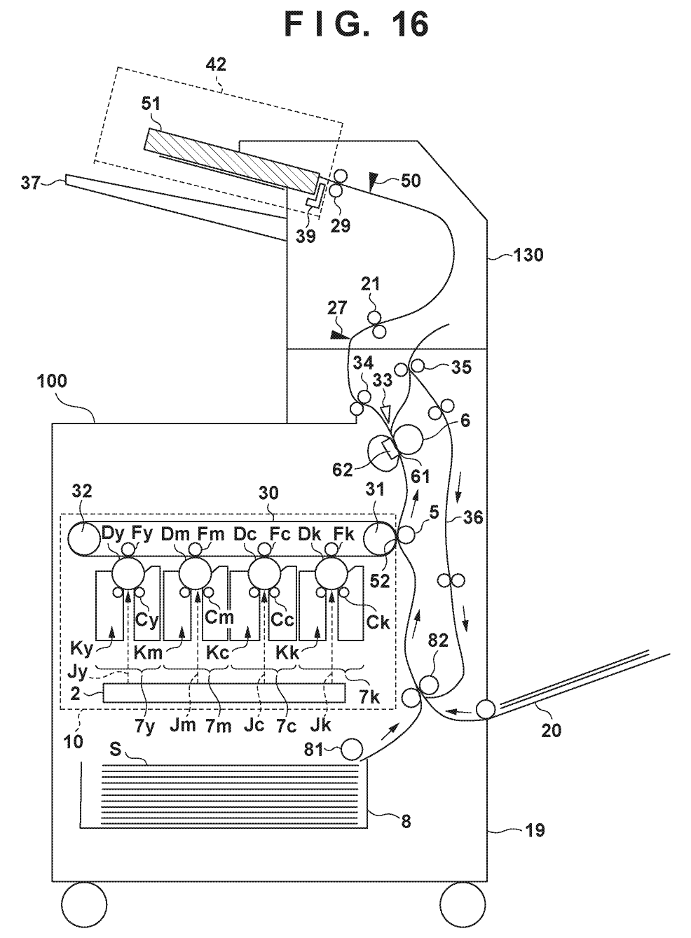

Although FIG. 1 illustrates the post-processing apparatus 130 having the thermal compression adhering unit 51 as being disposed next to the image forming apparatus 100, this is merely an example. As illustrated in FIG. 16, the post-processing apparatus 130 and the thermal compression adhering unit 51 may be disposed in an upper part of the main body of the image forming apparatus 100. In this case, the discharge rollers 34 directly pass the sheet S to the post-processing apparatus 130. When the sheet sensor 27 detects the leading end of the sheet S, the inlet rollers 21 convey the sheet S. Furthermore, the kick-out roller pair 29 conveys the sheet S to the intermediate stacker portion 42. Note that the conveyance direction of the sheet S to the intermediate stacker portion 42 in FIG. 16 is opposite from the conveyance direction of the sheet S to the intermediate stacker portion 42 in FIG. 1.

### 5. Conclusion

The intermediate stacker portion 42 is an example of a stacker unit on which a plurality of sheets are stacked, the plurality of sheets including a sheet on which an image and an adhesive layer are formed by an image forming unit using toner. The thermal compression adhering unit 51 is an example of a thermal compression adhering unit configured to make a booklet by heating and pressing the adhesive layer formed on at least one sheet among the plurality of sheets. The CPU 801 is an example of a control unit configured to control the thermal compression adhering unit. The usage amount of the process cartridge 7 and the wear degree of the photosensitive drum D are examples of the wear state of the image forming unit. The exposure light intensity for forming the adhesive image is an example of an image forming condition of the adhesive layer, used in the image forming unit. The heating temperature, the thermal compression adhering time, and the applied pressure of the thermal compression adhering unit 51 are examples of thermal compression adhering conditions for the adhesive layer, used in the thermal compression adhering unit. This improves the method for making booklets.

As described in the first embodiment, the wear state of the process cartridge 7 affects the adhesion strength of the adhesive layer (the adhesive image). A target adhesion strength may be ensured by adjusting at least one of the exposure conditions and the thermal compression adhering conditions of the adhesive image in accordance with the wear state of the process cartridge 7.

As described in the first through third embodiments, the memory 700, the storage device 802, and the cloud 808 are examples of a storage unit configured to store a table, a formula, or a program module used to determine the booklet making condition.

Providing the memory 700 in the process cartridge 7 makes it possible to reliably store the wear state for each process cartridge 7.

As suggested by the correction tables 901, 902, 1201, 1202, and the like, the booklet making condition may be determined using a table, a formula, or a program module. Alternatively, the storage unit may be implemented by the storage device 802 connected to the CPU 801.

As mentioned in the first to third embodiments, the CPU 801 may obtain or determine the booklet making condition using the cloud 808.

As suggested by the correction tables 901, 902, 1201, and 1202, the correction tables 901, 902, 1201, and 1202 may hold correction values. This makes it possible to reduce the computational load on the CPU 801.

As described in the first to third embodiments, the memory 700 or the storage device 802 may store an initial value (a reference value) for the booklet making condition. The CPU 801 may use the correction value to correct the initial value.

As mentioned in the first to third embodiments, when the CPU 801 transmits at least one of the wear state and the environmental condition to the cloud 808, the cloud 808 may generate a booklet making condition corresponding to at least one of the wear state and the environmental condition. The CPU 801 may receive the booklet making condition transmitted from the cloud 808 and use the booklet making condition.

The heating temperature, applied pressure, or thermal compression adhering time of the thermal compression adhering unit 51 may be adjusted to ensure adhesion strength.

The adhesion strength increases as the thermal compression adhering unit 51 increases the heating temperature, the applied pressure, or the thermal compression adhering time. Note that other control parameters may be adjusted as long as the control parameters contribute to the increase in the adhesion strength.

As mentioned in the first embodiment, the cumulative number of rotations of the developing roller 125 may be taken into account. As mentioned in the third embodiment, the number of times an adhesive image is formed on the surface of the photosensitive drum D may be taken into account.

As mentioned in the third embodiment, the adhesion strength may be increased by adjusting the light intensity of the exposure apparatus 2.

Using a higher exposure light intensity for the adhesive image than the user image increases the toner amount of the adhesive image. In other words, the adhesion strength is increased.

The memory 700 may function as a first storage unit configured to store an address corresponding to a combination of a wear state and an environmental condition. The storage device 802 may function as a second storage unit having a plurality of storage regions each storing a table used to determine the booklet making condition. The CPU 801 obtains an address corresponding to a combination of a wear state and an environmental condition from the first storage unit. The CPU 801 reads out a table used to determine the booklet making condition from the storage region associated with the obtained address among the plurality of storage regions provided in the second storage unit. The CPU 801 may determine the booklet making condition based on the table that has been read out. This reduces the storage capacity of the memory 700.

The environmental sensor 805 is an example of a detecting unit.

Although the ambient temperature is taken into account in the first embodiment, this is merely one example. The ambient humidity may be taken into account as well.

The conveyance roller pair 82 is an example of a conveying unit. The image forming portion 10 is an example of an image forming unit. The image forming system 1 is an example of an image forming apparatus.

The post-processing apparatus 130 is an example of a booklet making apparatus. The CPU 801 may be provided in the image forming apparatus 100, in the post-processing apparatus 130, or outside the image forming apparatus 100 and the post-processing apparatus 130. The functions of the CPU 801 may be distributed among a processor provided in the image forming apparatus 100 and a processor provided in the post-processing apparatus 130.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016283, filed February 3, 2025, which is hereby incorporated by reference herein in its entirety.

What is claimed is:

1. A booklet making apparatus comprising:
a stacker unit on which a plurality of sheets are stackable, the plurality of sheets including a sheet on which an image and an adhesive layer are formed by an image forming unit using toner;
a thermal compression adhering unit configured to make a booklet by heating and pressing the adhesive layer formed on at least one sheet among the plurality of sheets; and
a control unit configured to control the thermal compression adhering unit,
wherein the control unit adjusts a booklet making condition in accordance with at least one of a wear state of the image forming unit and an environmental condition in an environment in which the image forming unit is installed, the booklet making condition including at least one of:
(i) an image forming condition for the adhesive layer, which is used in the image forming unit, and
(ii) a thermal compression adhering condition for the adhesive layer, which is used in the thermal compression adhering unit.

2. The booklet making apparatus according to claim 1,
wherein the image forming unit includes:
a photosensitive member;
an exposure unit configured to form an electrostatic latent image by irradiating the photosensitive member with light;
a developing unit configured to form the image and the adhesive layer on the photosensitive member by using toner to develop the electrostatic latent image formed on the photosensitive member;
a transfer unit configured to transfer the image and the adhesive layer from the photosensitive member onto the at least one sheet; and
a fixing unit configured to heat and press the at least one sheet onto which the image and the adhesive layer were transferred,
wherein the photosensitive member and the developing unit are mounted in a process cartridge that is replaceable, and
the wear state of the image forming unit is a state that is based on a cumulative usage count or a cumulative usage time of the process cartridge.

3. The booklet making apparatus according to claim 2,
wherein the control unit accesses a storage unit storing a table, a formula, or a program module used to determine the booklet making condition based on the wear state and the environmental condition, obtains the table, the formula, or the program module from the storage unit based on the wear state and the environmental condition, and determines the booklet making condition using the table, the formula, or the program module.

4. The booklet making apparatus according to claim 3,
wherein the storage unit is provided in the process cartridge.

5. The booklet making apparatus according to claim 3,
wherein the storage unit is connected to the control unit or is provided in the control unit.

6. The booklet making apparatus according to claim 3,
wherein the storage unit is provided in a cloud capable of communicating with the control unit.

7. The booklet making apparatus according to claim 3,
wherein the table holds a correction value for correcting the booklet making condition.

8. The booklet making apparatus according to claim 7,
wherein the storage unit stores an initial value of the booklet making condition in advance, and
the control unit multiplies the correction value obtained from the table by the initial value or adds the correction value to the initial value.

9. The booklet making apparatus according to claim 1,
wherein the control unit obtains, from a cloud, the booklet making condition that is based on at least one of the wear state of the image forming unit and the environmental condition in the environment in which the image forming unit is installed.

10. The booklet making apparatus according to claim 1,
wherein the thermal compression adhering condition includes at least one of a heating temperature set in the thermal compression adhering unit, a pressure applied to the adhesive layer by the thermal compression adhering unit, and a thermal compression adhering time of the thermal compression adhering unit.

11. The booklet making apparatus according to claim 10,
wherein at least one of the heating temperature, the pressure, and the thermal compression adhering time is increased as wear of the image forming unit progresses.

12. The booklet making apparatus according to claim 2,
wherein the wear state is a state that is based on a cumulative number of rotations of the developing unit or a number of times an adhesive image for the adhesive layer was formed on the photosensitive member.

13. The booklet making apparatus according to claim 12,
wherein the image forming condition includes a light intensity of the exposure unit used to generate the adhesive image.

14. The booklet making apparatus according to claim 13,
wherein the light intensity of the exposure unit used to generate the adhesive image is increased as a wear degree of the photosensitive member increases.

15. The booklet making apparatus according to claim 1, further comprising:
a first storage unit configured to store an address corresponding to a combination of the wear state and the environmental condition; and
a second storage unit having a plurality of storage regions each storing a table used to determine the booklet making condition,
wherein the control unit obtains the address corresponding to the combination of the wear state and the environmental condition from the first storage unit, reads out the table used to determine the booklet making condition from a storage region, among the plurality of storage regions provided in the second storage unit, that is associated with the address, and determines the booklet making condition based on the table.

16. The booklet making apparatus according to claim 1, further comprising:
a detecting unit configured to detect the environmental condition,
wherein the control unit obtains the environmental condition using the detecting unit.

17. The booklet making apparatus according to claim 16,
wherein the environmental condition includes an ambient temperature.

18. An image forming apparatus comprising:
a conveying unit configured to convey a sheet;
an image forming unit configured to form an image and an adhesive layer on the sheet using toner;
a stacker unit on which a plurality of sheets output from the image forming unit are stackable;
a thermal compression adhering unit configured to make a booklet by heating and pressing the adhesive layer formed on at least one sheet among the plurality of sheets; and
a control unit configured to control the thermal compression adhering unit,
wherein the control unit adjusts a booklet making condition in accordance with at least one of a wear state of the image forming unit and an environmental condition in an environment in which the image forming unit is installed, the booklet making condition including at least one of:
(i) an image forming condition for the adhesive layer, which is used in the image forming unit, and
(ii) a thermal compression adhering condition for the adhesive layer, which is used in the thermal compression adhering unit.

19. An image forming system comprising an image forming apparatus, a booklet making apparatus, and a control unit,
wherein the image forming apparatus includes:
a conveying unit configured to convey a sheet;
a photosensitive member;
an exposure unit configured to form an electrostatic latent image on the photosensitive member by exposing the photosensitive member;
a developing unit configured to form a toner image including an adhesive layer by developing the electrostatic latent image using toner;
a transfer unit configured to transfer the toner image from the photosensitive member onto the sheet; and
a fixing unit configured to fix the toner image onto the sheet by applying heat and pressure to the sheet onto which the toner image was transferred,
the booklet making apparatus includes:
a stacker unit on which a plurality of sheets on which the toner image is formed are stackable; and
a thermal compression adhering unit configured to make a booklet by heating and pressing the adhesive layer formed on at least one sheet among the plurality of sheets, and
the control unit adjusts a booklet making condition in accordance with at least one of a wear state of the developing unit or the photosensitive member and an environmental condition of the image forming apparatus, the booklet making condition including at least one of:
(i) an exposure condition for the adhesive layer, which is used in the exposure unit, and
(ii) a thermal compression adhering condition for the adhesive layer, which is used in the thermal compression adhering unit.
